(19) United States
(12) Patent Application Publication
(10) Pub. No.: US 2022/0011444 A1
(43) Pub. Date: Jan. 13, 2022

(54) Apparatus, Systems And Methods For Grain Cart-Grain Truck Alignment And Control Using Gnss And / Or Distance Sensors

(71) Applicant: Ag Leader Technology, Ames, IA (US)

(72) Inventors: Scott Eichhorn, Ames, IA (US); Tony Woodcock, Ames, IA (US); Alan F. Barry, Nevada, IA (US); Roger Zielke, Huxley, IA (US)

(21) Appl. No.: 17/369,876

(22) Filed: Jul. 7, 2021

Related U.S. Application Data
(60) Provisional application No. 63/048,797, filed on Jul. 7, 2020.

(51) Int. Cl. G01S 19/39; G01S 19/40; B60R 16/023; B60W 30/10

(52) U.S. Cl. CPC G01S 19/393; G01S 19/396; G01S 19/40; B60R 16/023; B60W 2300/12; B60W 2520/06; B60W 2556/60; B60W 2556/50; B60W 2300/15; B60W 30/10

(57) ABSTRACT

The disclosure relates to apparatus, systems, and methods for a system for guiding a tractor and auger cart alongside a grain truck so the load can be transferred quickly with a high degree of position accuracy. This will avoid common issues with this process that result in collisions or spilled grain. The system will allow less qualified operators to perform at a higher level, eliminate errors that slow the process and/or result in down time, or slow the unloading process. Methods are disclosed that sense the position, orientation, and size of a receiving vehicle and create a guidance line for a tractor automated steering system to follow.

### CROSS-REFERENCE TO RELATED APPLICATION

This application claims priority to U.S. Provisional Application No. 63/048,797 filed Jul. 7, 2020 and entitled “Apparatus, Systems and Methods for Grain Cart-Grain Truck Alignment and Control Using GNSS and/or Distance Sensors,” which is hereby incorporated by reference in its entirety.

### TECHNICAL FIELD

This disclosure relates to systems for guidance, navigation, and positioning an offloading vehicle or implement for accurate transfer of agricultural materials to a receiving vehicle.

### BACKGROUND

In small grain and row crop harvesting operations, offloading from grain cart to grain truck (semi) is an action that requires precise alignment of the grain cart to the grain truck. The operator needs to prevent misalignment that results in spillage of grain and/or the collision of the grain cart or its auger with the grain truck.

It is understood that an operator needs to complete the offload/grain transfer quickly, so the grain cart can return to unload the combine and maintain the pace of harvesting. Doing this operation in a precise and efficient manner requires an operator with skill and experience. For many operators, it is stressful. In addition to the possibility of spilled grain, collision or misalignment can cause time delays as the operator must move slowly and must spend time maneuvering for realignment.

There is a need in the art for improved systems for alignment, navigation, and guidance for grain transfer and unloading during harvest operations.

### BRIEF SUMMARY

Discussed herein are various devices, systems and methods relating to grain cart and grain truck alignment for unloading purposes. In various implementations, the alignment operations are manual, semi-automatic, or fully automated.

For this document, the term grain cart refers to the combination of grain wagon and the tractor that pulls it or other implementation of a vehicle design for the transfer of grain/crop from a harvester to another vehicle as would be appreciated. The term grain truck refers to the combination of truck and grain trailer (pulled by the truck), truck and grain box (rigidly mounted to the truck frame), or the onloading/storage vehicle as would be appreciated by those of skill in the art.

Various implementations of the system can quickly and reliably align the grain cart and auger to the truck, this clearly has value for one or more of: lowering stress of the grain cart operator, making inexperienced grain cart operators faster and more reliable, minimizing wasted time in getting aligned, preventing grain spillage due to misalignment, and/or preventing collision of the grain cart auger and the grain truck. Further rationales of course exist and are appreciated.

Further, many times a grain cart will offload into multiple vehicles during the harvest. There may be a mixture of trucks owned by the farming operation and/or hired trucks needed for additional capacity at the peak of the harvest season, as would be readily appreciated. These grain trucks may have various dimensions and configurations such as a mixture of tractor trailer (semi) vehicles, straight truck configurations, grain wagons pulled by tractors, and the like, as would be readily appreciated. For this reason and others, in certain implementations, the disclosed systems, methods and devices sense configurations, dimensions, and/or measurements of the grain truck(s), certain non-limiting examples being the length, height, and/or width of the truck grain box, such as, for example, on approach. This sensing of at least one configuration, dimension, or measurement is useful to help determine the best location to position the grain cart to load into a specified location of the grain truck, such as the center of the receiving grain truck box, and to accurately position and move the grain cart along the length of the receiving grain truck, as would be appreciated. In certain further implementations, using such configurations, dimensions, and/or measurements taken/sensed by various sensors as the tractor and grain cart approach the grain truck, individual unique grain trucks can be identified and operating parameters can be automatically adjusted to match the particular grain truck.

Further, many grain carts have adjustable discharge spouts/augers that are controlled by the grain cart tractor operator. In certain further implementations, the system includes an automated means of control of discharge spouts/augers based on the location of the discharging grain cart and the receiving grain truck. In certain implementations, these adjustable unloading augers that can be moved hydraulically by the grain cart tractor operator to match the height or other dimension/measurement of the receiving grain truck box. In various implementations, while unloading, the disclosed systems, methods and devices can control various grain cart features, such as the forward travel speed, spout position, unload auger pitch, unload feed gate, and PTO speed to fully and evenly fill the receiving grain truck box.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One Example relates to a grain cart guidance system, including at least one GNSS receiver and at least one cart ECU, where the grain cart guidance system is configured to plot a grain cart guidance line for alignment of the grain cart along one or more grain trucks. Other implementations of this Example include corresponding computer systems, apparatus, and computer programs recorded on one or more computer storage devices, each configured to perform the actions of the methods.

In Example 1 a grain cart guidance system, comprising at least one GNSS receiver and at least one cart ECU in communication with the at least one GNSS receiver, wherein the grain cart guidance system is configured to plot a grain cart guidance line for alignment of the grain cart along one or more grain trucks.

Example 2 relates to the guidance system of Example 1, further comprising an auger control system.

Example 3 relates to the grain cart guidance system of Example 1, wherein the at least one GNSS receiver is configured to determine one or more of a position of the one or more grain trucks, a heading of the one or more grain trucks, and a speed of the one or more grain trucks.

Example 4 relates to the grain cart guidance system of Example 1, further comprising a display for displaying the grain cart guidance line for manual navigation by an operator.

Example 5 relates to the grain cart guidance system of Example 1, wherein the guidance system is in communication with an automatic steering system for automatic steering of the grain cart along the grain cart guidance line.

Example 6 relates to the grain cart guidance system of Example 1, further comprising at least two GNSS receivers disposed on the each of the one or more grain trucks and in communication with the at least one cart ECU.

Example 7 relates to the grain cart guidance system of Example 1, further comprising one or more multi-dimensional sensors disposed on the grain cart configured to measure an orientation of the one or more grain trucks and relative positions of the one or more grain trucks and grain cart.

In Example 8 an agricultural guidance system, comprising a position sensor configured to determine a location and an orientation of a grain truck relative to a grain cart and a processor configured to receive the location and the orientation of the grain truck relative to the grain cart, wherein the system is configured to generate one or more guidance paths for alignment of the grain cart and the grain truck.

Example 9 relates to the agricultural guidance system of Example 8, wherein the position sensor is one or more of a GNSS receiver, a 2D distance sensor, and a 3D distance sensor.

Example 10 relates to the agricultural guidance system of Example 8, further comprising one or more reflectors comprising distinct patterns for identification of the grain cart and the grain truck.

Example 11 relates to the agricultural guidance system of Example 8, further comprising a display configured to display the one or more guidance paths to an operator for navigation.

Example 12 relates to the agricultural guidance system of Example 8, wherein the grain cart comprises an adjustable spout, and wherein the system is configured to position the adjustable spout to distribute grain in the grain truck.

Example 13 relates to the agricultural guidance system of Example 12, wherein the system is configured to automatically adjust a projection angle and/or a spout angle of the adjustable spout.

Example 14 relates to the agricultural guidance system of Example 12, wherein the system is configured to position the adjustable spout to correct any misalignment of the grain cart and grain truck.

In Example 15 a guidance system for a grain cart and a grain truck, comprising: a first position sensor disposed on the grain cart, the first position sensor configured to determine at least one of location, heading, and speed of the grain cart, a first electronic control unit (ECU) disposed on the grain cart and in communication with the first position sensor; a second position sensor disposed on the grain truck, the second position sensor configured to determine at least one of location, heading, and speed of the grain truck, a second ECU disposed on the grain truck and in communication with the second position sensor, and a data link between first ECU and the second ECU, wherein the system is configured to plot one or more grain cart guidance lines for alignment of the grain cart along the grain truck.

Example 16 relates to the system of Example 15, further comprising a third position sensor disposed on the grain truck and in communication with the second position sensor.

Example 17 relates to the system of Example 15, further comprising a cloud-based server, wherein the first ECU and the second ECU are in electronic communication with the cloud-based server.

Example 18 relates to the system of Example 15, wherein the data link is an integrated cellular modem, a WiFi connection, a cellular hotspot.

Example 19 relates to the system of Example 15, wherein an automatic steering system on the grain cart steers the grain cart along the one or more grain cart guidance lines.

Example 20 relates to the system of Example 15, further comprising one or more distance sensors disposed on the grain truck and/or the grain cart configured to determine an orientation of the grain truck.

While multiple implementations are disclosed, still other implementations of the disclosure will become apparent to those skilled in the art from the following detailed description, which shows and describes illustrative implementations of the disclosed apparatus, systems, and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic representation of the system, according to one implementation.

FIG. 2 is a top view of the system with a single GNSS sensor and data link, according to one implementation.

FIG. 3 is a top view of the system with a dual orthogonal heading GNSS sensor and data link, according to one implementation.

FIG. 4 is a top view of the system with a dual parallel heading GNSS sensor and data link, according to one implementation.

FIG. 5 is a top view of the system with a single GNSS sensor and a single-point LiDAR sensor, according to one implementation.

FIG. 6 is a top view of the system with a single GNSS sensor and two more single-point LiDAR sensors, according to one implementation.

FIG. 7 is a top view of the system with a single GNSS sensor and a multi-dimension distance sensor, according to one implementation.

FIG. 8 is a schematic representation of the system, according to one implementation.

FIG. 9 is a schematic representation of a grain cart portion of the system, according to one implementation.

FIGS. 10A-C depict a top view of navigation of a grain cart to a grain truck according to the disclosed system, according to one implementation.

FIG. 11 is a schematic representation of a grain cart portion of the system, according to one implementation.

FIGS. 12A-C depict a top view of navigation of a grain cart to a grain truck according to the disclosed system, according to one implementation.

FIG. 13 is a top view of the system utilizing a distance sensor, according to one implementation.

FIGS. 14A-B is a top view of the system showing possible misalignment of the grain truck and grain cart in a system with a single GNSS sensor, according to one implementation.

FIG. 15A is a front view of a grain truck with reflector, according to one implementation.

FIG. 15B is a front view of a grain truck with reflector, according to one implementation.

FIG. 16A is a top view of the system utilizing a reflector, according to one implementation.

FIG. 16B is a top view of the system utilizing a reflector, according to one implementation.

FIG. 17A is a front view of a grain truck with a dual reflector, according to one implementation.

FIG. 17B is a perspective view of a grain truck with a dual reflector, according to one implementation.

FIG. 18A is a top view of the system utilizing a dual reflector on the grain truck, according to one implementation.

FIG. 18B is a top view of the system utilizing a dual reflector on the grain truck, according to one implementation.

FIG. 19A is a top view of the system where the grain cart detects a reflector and other surfaces, according to one implementation.

FIG. 19B is a top view of the system where the grain cart detects a reflector and other surfaces, according to one implementation.

FIG. 19C is a perspective view of a grain truck with a reflector, according to one implementation.

FIG. 19D shows a sensor view of the grain truck reflectors, according to one implementation.

FIG. 20 shows 2D LiDAR points of a grain truck from a top down view, according to one implementation.

FIG. 21 is a schematic representation of a grain cart portion of the system, according to one implementation.

FIG. 22 is a front view of multiple positions of an adjustable auger, according to one implementation.

FIG. 23A is a side view of an auger spout in a more extended position, according to one implementation.

FIG. 23B is a side view of an auger spout in a more retracted position, according to one implementation.

FIG. 24 is a side view of grain unloading into a grain truck from an auger attached to a grain cart, according to one implementation.

FIG. 25 is a top view of grain unloading into a grain truck from an auger attached to a grain cart, according to one implementation.

FIG. 26 is a top view of grain unloading into a grain truck from an auger attached to a grain cart having a distance sensor, according to one implementation.

### DETAILED DESCRIPTION

The disclosure relates generally to apparatus, systems, and methods for guiding a tractor and auger cart alongside a grain truck so the load can be transferred quickly from the auger car to the grain truck with a high degree of position accuracy. This will avoid common issues with this process that result in collisions or spilled grain. The system will allow less qualified operators to perform at a higher level, eliminate errors that slow the process and/or result in down time, or slow the unloading process. Methods are disclosed that sense the position, orientation, and size of a receiving vehicle and plot a guidance line for an operator to manually follow or for a grain cart/tractor automated steering system to follow.

In one implementation, a GNSS receiver on the grain truck and/or trailer is used to provide grain truck position and heading information to the grain cart. The term GNSS refers to Global Navigation Satellite System. GNSS is the standard generic term for satellite navigation systems that provide autonomous geo-spatial positioning with global coverage. Certain non-limiting examples include GPS, GLONASS, Galileo, Beidou and other global navigation satellite systems. It is understood that, for example, the terms GNSS and GPS (global positioning system) are used interchangeably in the disclosure.

In further implementations, the grain cart uses one or more 2D or 3D distance sensor(s) on the grain cart or tractor to detect the location and orientation of the grain truck or trailer that is ready to receive grain from the grain cart. The 2D or 3D distance sensors considered herein are capable of sensing objects within a given range and reporting their distance and position in a 2D plane and/or 3D space, as would be understood.

In either of the above implementations, the positions and orientation information is used to create a guidance path for the tractor automatic guidance system to follow or for an operator to manually follow with or without assisted steering. In certain implementations, when in range, the operator can engage the guidance system and allow it to position the grain cart alongside the receiving vehicle (grain truck). Using information measured or transmitted about the receiving vehicle dimensions such as the width, length, and height of the grain truck's grain box, the grain cart's adjustable auger can be accurately adjusted to clear the side of the truck box. This trailer dimensional data can also be used to position the discharge of the auger in the truck box to maximize the capacity of the grain truck without risk of spilling grain over the side. Also, in various implementations, if the grain cart has an adjustable discharge spout, the spout can be controlled to evenly distribute the grain across the width to the truck box for even filling.

Various implementations of the system can be used in conjunction with any of the devices, systems or methods taught or otherwise disclosed in: U.S. Pat. No. 10,684,305, issued Mar. 8, 2019, and entitled “Apparatus, Systems, and Methods for Cross Track Error Calculation From Active Sensors”; U.S. patent application Ser. No. 16/918,300, filed Jul. 1, 2020, and entitled “Apparatus, Systems, and Methods for Eliminating Cross-Track Error”; U.S. patent application Ser. No. 16/921,828, filed Jul. 6, 2020, and entitled “Apparatus, Systems and Methods for Automatic Steering Guidance and Visualization of Guidance Paths”; U.S. patent application Ser. No. 16/939,785, filed Jul. 27, 2020, and entitled “Apparatus, Systems, and Methods for Automated Navigation of Agricultural Equipment”; U.S. patent application Ser. No. 16/997,361, filed Aug. 19, 2020, and entitled “Apparatus, Systems and Methods for Steerable Toolbars”; U.S. patent application Ser. No. 17/132,152, filed Dec. 23, 2020, and entitled “Use of Aerial Imagery For Vehicle Path Guidance and Associated Devices, Systems, and Methods”; U.S. patent application Ser. No. 17/323,649, filed May 18, 2021, and entitled “Assisted Steering Apparatus and Associated Systems and Methods”; U.S. Provisional Patent Application 63/054,411, filed Jul. 21, 2020, and entitled “Visual Boundary Segmentations and Obstacle Mapping for Agricultural Vehicles”; and U.S. Provisional Patent Application 63/186,995, filed May 11, 2021, and entitled “Calibration Adjustment for Automatic Steering Systems.”

### GNSS Guidance

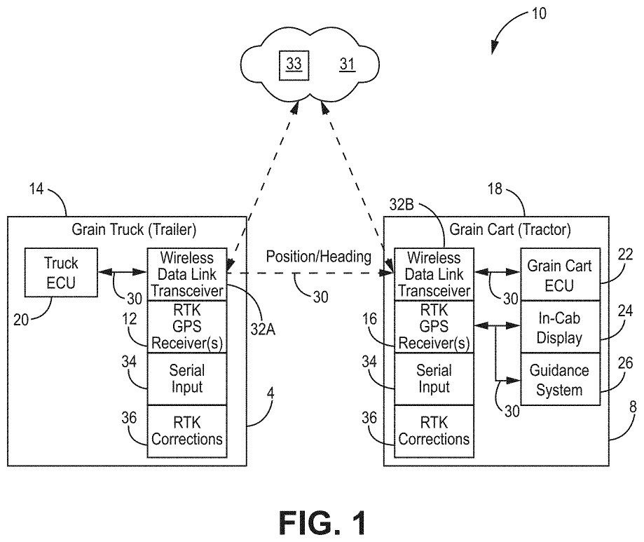

As shown in the guidance system 10 of FIG. 1, a truck GNSS receiver 12 is mounted on the grain truck 14, or grain trailer 2 attached to a truck 14, and a cart GNSS receiver 16 is mounted on the grain cart 18 or the tractor that pulls the grain cart 18. It is understood that in these and other implementations, the grain truck 14 and grain cart 18 can comprise trailers that are in operational communication with the truck 14 and/or cart 18, as would be readily appreciated in the art.

In various implementations, the truck GNSS receiver 12 is configured to calculate the position of the grain truck 14 at a fixed rate such as about 10 Hz. It is readily appreciated that any of a large range of frequencies would be possible, however, ranging from about 1 Hz to about 100 Hz or more. The truck GNSS receiver 12 can also calculate other truck position and orientation information such as the heading and speed of the grain truck 14, as would be appreciated.

In these implementations, an electronic control unit (ECU) or truck ECU 20, is also located on/in the grain truck 14. The truck ECU 20 utilizes the position, heading, and speed from the truck GNSS receiver 12 to calculate the position and orientation of the grain truck 14 and/or trailer 2 attached to the grain truck 14. In turn, the cart 18 according to these implementations has a cart ECU 22 as well as optional display 24 and guidance system 26 components.

The truck ECU 20, according to various implementations, is in electrical communication with the grain cart ECU 22 or a cloud system 31 via a wireless communication or a data link 30 over communications systems 32 such as data link transceivers 32, to transfer the grain truck 14 position and orientation information to the grain cart ECU 22. Further components, such as serial inputs 34 and RTK connections 36 may be provided in both the truck 14 and cart 18 to facilitate data collection, processing, storage and/or transmission, as would be appreciated.

Continuing with FIG. 1, in use, the grain cart ECU 22 uses the position and orientation information of the truck 14, along with the cart 18 GNSS position to determine its distance from and relative orientation to the grain truck 14. With distance and orientation information, the grain cart ECU 22 can do one or more of: present the distance and orientation information to the grain cart operator via the display 24 to allow manual guidance along the correct path and/or input the distance and orientation data to the optional grain cart automatic guidance system 26 to correctly position and align the grain cart 18 to the truck 14 for unloading, as would be appreciated.

In addition to left/right steering control, the described guidance system 10 may also include speed control, gear control, direction control, that is forward/reverse, and other automatic steering controls as would be appreciated. With speed control, the speed of the grain cart 18 tractor or other towing vehicle could be controlled so that distribution of the grain in the grain truck 14 follows an optimal, or user-defined pattern. Direction control would allow the guidance system 10 to move the grain cart 18 in reverse, allowing distribution of the grain into the grain truck 14.

### Calculating Grain Truck Heading Using GNSS

### Single GNSS Receiver

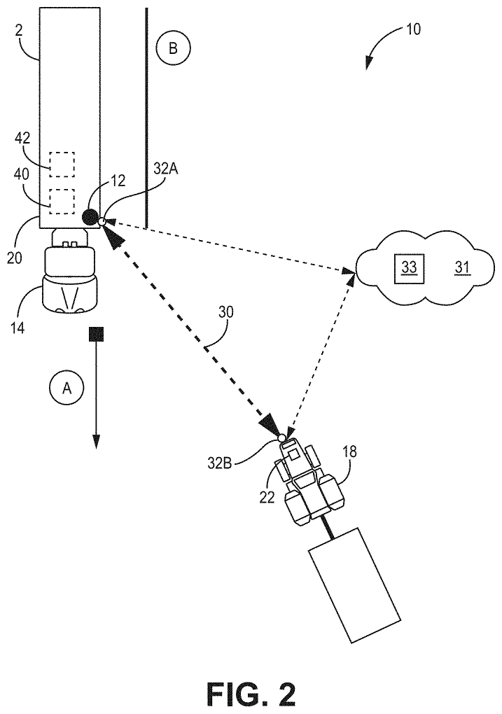

As illustrated in FIG. 2, a single GNSS receiver 12 is used on the grain truck 14 (or trailer 2) to determine the position and orientation information of the grain truck 14, shown at A, and to plot a grain cart 18 guidance line B. One of the potential limitations of this approach is that heading A may only be determined if there is movement of the GNSS receiver 12. That is, in certain implementations, a GNSS receiver 12 on a stationary truck 14 may not provide an accurate position and orientation information that reflects the true heading and orientation of the truck 14. Another potential issue with heading calculations derived from a single GNSS receiver 12 is that with certain prior known systems, the heading calculation may be based only on the most recent two GNSS positions determined at the given receiver 12 update rate. In such situations, if the distance between positions is small due to slow speed of the truck 14, and therefore the receiver 12, the calculated heading may have excessive error from the true truck orientation/heading A that prevents the system 10 from being able to properly align the grain cart 18 tractor to the truck 14 and/or trailer 2.

Accordingly, various implementations of the disclosed guidance system 10 include a method for calculating accurate truck 14 headings A that are close to the true truck 14 heading such that the system 10 can accurately and reliably align the grain cart 18 to the truck 14 via an accurate cart guidance line B. Such heading calculation methods disclosed herein include non-limiting examples such as: speed filtering, that is only accepting heading values if speed is greater than a set threshold; heading averaging, that is using multiple measured heading values to reduce signal noise and smooth the measured heading; utilizing GNSS position to examine a set number of recent positions based on distance or time to determine heading or estimate heading accuracy; and kinematic modeling of trailer movement based on the GNSS position. In various implementations, one or more of these heading calculation methods may be implemented together by the system 10. Further implementations are of course possible and would be readily appreciated by those of skill in the art.

### Speed Filtering

Continuing with FIG. 2, various implementations of the system 10 for establishing an accurate truck heading A use speed filtering. In one such example, the truck ECU 20 and its associated software comprises an array of the last twelve valid GNSS headings (such as about 3 seconds of sampled GNSS headings/data) are stored, such that a valid GNSS heading A is defined as any position update where the measured speed was greater than a specified threshold, such as about 0.5 miles per hour or 0.224 meters/second. In various implementations, the last twelve GNSS headings can then be averaged to calculate an estimated heading A. Of course, alternative threshold speeds and number of headings can be used.

In certain of these single-GNSS implementations, the truck operator must move the truck 14 forward in a straight line for a certain distance before stopping the truck 14 to await grain onload. In various implementations, a straight-line distance of about 30 ft (at speeds greater than 0.5 mph) may be required to establish an accurate heading.

### Heading Averaging

In implementations of the system 10 utilizing heading averaging, the truck ECU 20 stores an array of past GNSS positions based on time or distance. The heading A, shown in FIG. 2, of the grain truck 14/trailer 2 is then calculated based on a best-fit algorithm for a line that is closest to the stored previous positions. The truck ECU 20 according to certain of these implementations also evaluates the past GNSS positions to determine if the truck 14/trailer 2 was in a turn and the calculated heading may not be valid. If the truck ECU 20 is configured to provide feedback or status to the truck operator, it provides a display of heading accuracy and confidence for manual feedback. In certain of these implementations, the truck 14 operator would then use the displayed heading to continue to drive the truck 14 forward in a straight line until an accurate heading for the trailer 2/truck 14 is achieved.

### Kinematic Modeling

Various implementations of the system 10, shown for example in FIG. 2, establish the truck heading A, using a kinematic modeling method for the truck 14/trailer 2. Kinematic modeling, for heading calculation, uses a mathematical model for determining trailer 2 position and therefore truck heading A. The kinematic model estimates how the truck 14/trailer 2 moves in the field. The position of the GNSS receiver 12 on the trailer 2 (or truck 14) is known. The mounting location (geometry) of the GNSS receiver 12 is applied to the kinematic model and then the actual position data, heading, and speed from the GNSS receiver 12 is fed into the model. The model is then able to estimate the orientation of the trailer 2 (or truck 14), which allows the model to calculate the heading A of the trailer 2 (or truck 14) for alignment with the grain cart 18 in a further step. The use of kinematic modeling may allow accurate heading determination without requiring a minimum drive-straight distance before stopping for onload.

Various implementations of the guidance system 10 having a single GNSS receiver 12 that perform the calculation for establishing a truck heading A may use a combination of the heading calculation methods previously described.

### Augmenting Grain Truck Heading with Sensors

For the single-GNSS heading, the system 10 may include additional optional sensors to improve heading A accuracy and reliability. In various implementations, the additional optional sensors may be used in addition to or in coordination with the heading calculation methods discussed above. In various implementations, the truck 14 (or trailer 2) has one or more of an optional a magnetometer 40 and/or an optional inertial measurement unit (IMU 42).

A magnetometer 40 is an electronic compass that measures heading A by measuring the earth's magnetic field, as would be understood. In implementations of the system 10 comprising a magnetometer 40, the heading A provided by the magnetometer 40 is corrected by using the GNSS position to reflect true heading A, or vice versa. The magnetometer 40, according to various implementations, may also be used in combination with other heading calculation methods to improve accuracy and reliability of the calculated heading.

In various implementations, the IMU 42 is an electronic device that measures motion and angular rate using a combination of accelerometers and gyroscopes, as would be appreciated. In implementations of the system 10 having an IMU 42, the IMU 42 is used in combination with the GNSS receiver 12 to calculate the true heading A of the trailer 2 (or truck 14). Because an IMU 42 can measure both motion and angular rate, it can detect the motion of a turn and allow the true heading of the trailer 2 (or truck 14) to be calculated. According to various implementations, the IMU may also be used in combination with other heading calculation methods and/or a magnetometer 40 to improve accuracy and reliability of the calculated heading. In further implementations, the magnetometer 40 and/or IMU may be used in connection with the various dual GNSS receiver implementations discussed below.

### Dual GNSS Receivers

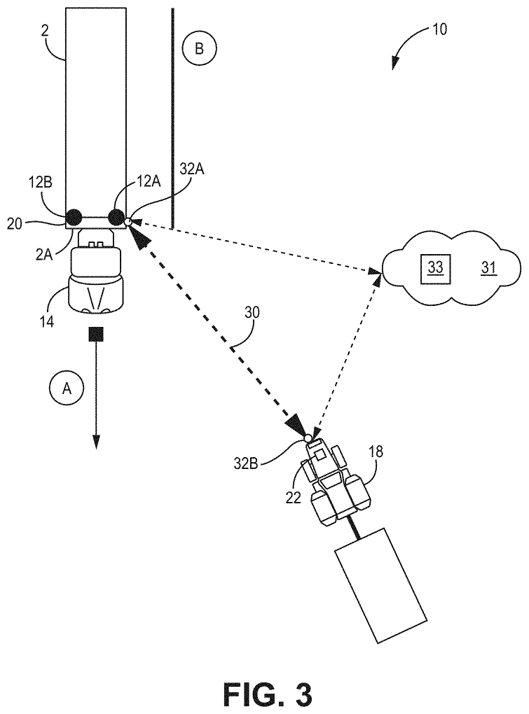

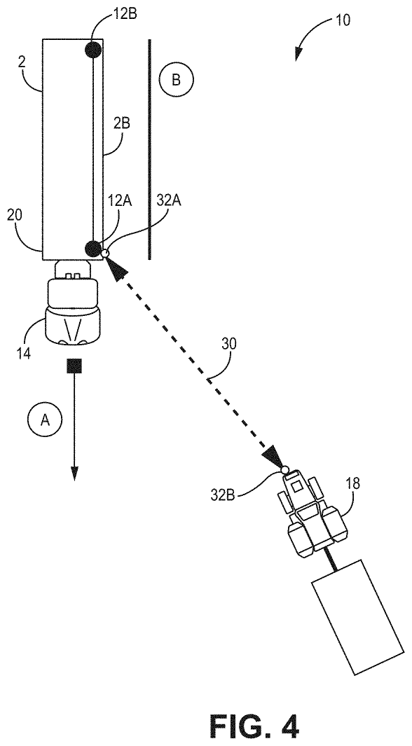

Turning to the implementations of FIGS. 3-4, the grain truck 14 (or trailer 2) has two GNSS receivers 12A, 12B with RTK corrections from the same source. The placement of the GNSS receivers 12A, 12B is measured and/or known to the system 10, so the orientation to the trailer 2 would be known. The heading from one receiver 12A to another 12B can be determined by comparing the calculated GNSS positions. Once the heading between receivers 12A, 12B is calculated, the GNSS receiver orientation angle can be applied to calculate the true heading A of the truck 14 (or trailer 2).

In the implementation of FIG. 3, an orthogonal arrangement of one receiver 12A to another 12B would have the GNSS receivers 12A, 12B parallel to the front side of the trailer 2. This would be orthogonal to the long side of the trailer 2, which is the side that the grain cart 18 aligns to for unloading.

In a parallel arrangement such as that of FIG. 4, the GNSS receivers 12A, 12B are parallel to the long side 2B of the trailer 2, so the heading from the rear receiver 12B to the front receiver 12A matches the heading A of the truck 14/trailer 2. The advantage of the system 10 with dual-GNSS receivers 12A, 12B for heading calculation is that the heading of the trailer 2 is always known, regardless of how the truck 14/trailer 2 has been driven. Thus, there are no restrictions on how the truck operator moves and positions the truck 14 for onload. Any of the previously discussed heading calculation methods may be used in conjunction with a dual-GNSS receiver implementation of the system, as would be appreciated.

### Data Link

Continuing with FIGS. 2-4, once the grain truck 14 is positioned for onload and the position and orientation of the grain truck 14 and trailer 2 are determined, the positions and orientation information is communicated to the grain cart 18 so that alignment (A-B) can be performed. Various implementations of the system 10 use a wireless data link 30, or other communication method as would be appreciated. One implementation includes a one-way data link 30 with the transmitter 32A on the grain truck 14 and the receiver 32B on the grain cart 18. The form of wireless communication may be a point-to-point or point-to-multipoint data link 30. Possible implementations use on or more of the following communications mechanisms: WiFi, cellular, Radio Frequency Modem (Serial), Radio Frequency Mesh Networks (such as Zigbee-802.15.4) and/or Light/Infrared. Such examples are of course illustrative and non-limiting as to the various data links 30 and components that are appreciated by those of skill in the art. It is further understood that the truck 14 position and orientation information transfer 30 may be direct—that is from grain truck 14 to grain cart 18—or routed through a cloud-based information distribution system 31, shown for example in FIG. 2.

In one such cloud-based system 31, the truck ECU 20 transmits data such as current position and orientation to a remote server 33. In these implementations, the grain cart ECU 22 is also connected to the cloud-based system 31 and is configured to receive data. The remote server 33 notifies and provides the identification and current position and orientation for active grain trucks 14 that are relevant to it. Relevance can be determined by position, such as proximity to the grain cart 18, availability, or other parameter as would be recognized.

In one exemplary implementation featuring the cloud system 31, the remote server 33 automatically plots a guidance line B for the specific grain cart 18. The guidance line B is then automatically transferred to the grain cart 18 guidance system. In various implementations, the guidance line B can include more than just the parallel path next to the truck 14/trailer 2. For example, the guidance line B can also include a planned path from the current location of the grain cart 18 to the optimal aligned position. This cloud-based approach may also be used to guide an autonomous (i.e. remote or computer-operated) grain carts 18 for unloading into the grain trucks 14.

Continuing with FIGS. 2-4, the data link 30 described herein also allows for fleet operations, that is, one or more grain trucks 14 are able to provide position and heading information to one or more grain carts 18. In certain of these implementations, in addition to position and heading information, each grain truck 14 also provides a unique identifier via the data link 30, as will be discussed further below. The unique identifier allows the grain cart 18 and/or cloud system 31 the ability to track loading information to/for a specific grain truck 14. This, in turn, allows for the tracking of grain transport from field to truck 14 to storage, delivery, or sale point, as would be readily appreciated.

As such, certain implementations of the system 10 facilitate managing grain cart 18 and grain truck 14 alignment for multiple grain carts 18 and multiple trucks 14 operating in the same field. One illustrative implementation includes a cloud-based system 31 where a farming operation uses a single account for connecting and distributing data to and from all its cloud-connectable equipment, as would be understood.

In this example, each grain truck 14 operating for the farming operation and servicing the active field of operation is equipped with the GNSS position reporting system 4 of FIG. 1 that includes a GNSS receiver 12, ECU 20, and data link transmitter 32A. The data link transmitter 32A may be an integrated cellular modem, a WiFi connection to a cellular phone, or cellular WiFi hotspot. The data link transmitter 32A is used to transfer truck 14 position and orientation information to the cloud-based information distribution system 31, as well as receive RTK correction information, allowing the GNSS receiver 12 to compute accurate position and orientation information.

Continuing with FIG. 1, like the grain trucks 14, each grain cart 18, in this example, operating in the active field of operation is equipped with a GNSS position reporting system 8 that includes a GNSS receiver 16, ECU 22, and data link transceiver 32B. The grain carts 18 also include a guidance system 26 that allows manual and/or automatic steering of the grain cart 18 (tractor). The cloud system 31 (i.e. remote server 33/computer) receives the active GNSS position and orientation information for all grain trucks 14 and grain carts 18 operating in the active field. The cloud system 31 then determines the distance from each grain cart 18 to all the grain trucks 14, finding which truck 14 is currently closest to the grain cart 18. For each grain cart 18, a guidance line B is plotted to parallel the nearest long side of the closest grain truck 14, like that shown in FIGS. 2-4. Once plotted, the guidance line B is communicated to the grain cart's guidance system 26. The grain cart operator then drives the grain cart 18 into position to engage on the guidance line B. In the case of manual guidance, the grain cart operator steers the tractor according to the steering indications provided by the guidance system 26. The guidance line B may also include positional information for the front and back of the grain truck 14 where the unload auger of the grain cart 18 will be positioned for unloading into the grain truck 14, as would be readily understood.

### Sensor Fusion

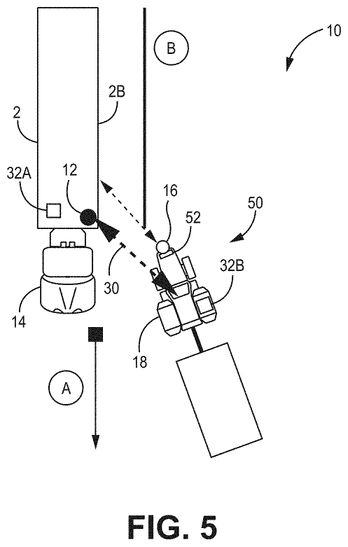

As shown in FIG. 5, the system 10 according to certain implementations achieves alignment of a grain cart 18 to a grain truck 14 for the purpose of unloading may include a GNSS receivers 12, 16 alongside other sensors in a multi-sensor or sensor fusion system 50. It would be appreciated that the sensor fusion system 50 may be used in addition to or in place of any of the heading calculation methods previously discussed. The sensors 52 in a sensor fusion system 50 can include a variety of additional sensing technologies. Certain non-limiting examples of additional sensing technologies include: single point LiDAR, three dimensional flash LiDAR, scanning LiDAR via single-plane or multi-plane or other distance measuring technologies including ultra-sonic distance sensors. It is appreciated and understood that LiDAR refers to light detection and ranging.

In an exemplary sensor fusion implementation, using a single-point LiDAR, shown in FIG. 5, the GNSS system provides the location and orientation of the trailer 2, via any of the previously described heading calculation methods. In this exemplary implementation, the position and heading information provided by the truck GNSS receiver 12 may not be accurate enough for precision guidance but are accurate enough to get the tractor 18 into position for single LiDAR measurement. In systems featuring the sensor fusion 50 system having a single-point LiDAR sensor 52, the LiDAR sensor 52 is positioned on the cart 18 so that as the cart 18 approaches the truck 14 for unloading, the LiDAR sensor 52 can accurately measure the distance to the side 2B of the truck 14/trailer 2. It is understood that the positions are known for the truck GNSS receiver 12 and cart GNSS receiver 16. Further, the position and angle are known for the single-point LiDAR sensor 52 on the cart 18. The LiDAR measurements taken as the cart 18 approaches the truck 14 are used to correct the distance and heading of the trailer 2 so that the guidance line B parallel to the long side 2B keeps the grain cart 18 and unloading auger in an optimal unload position.

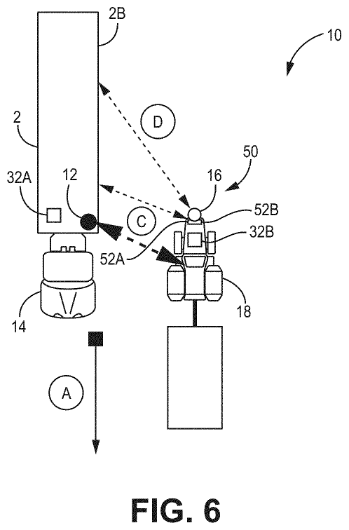

As shown in FIG. 6, another sensor fusion 50 implementation of the system 10 uses two or more single-point LiDAR sensors 52A, 52B, positioned for detection and measurement of the long side 2B of the grain trailer 2 as the grain cart 18 approaches and moves alongside the trailer 2. The use of multiple single-point LiDAR sensors 52A, 52B at different angles (shown at C and D) offers a wider angle for detection and measurement to the long side 2B of the trailer 2.

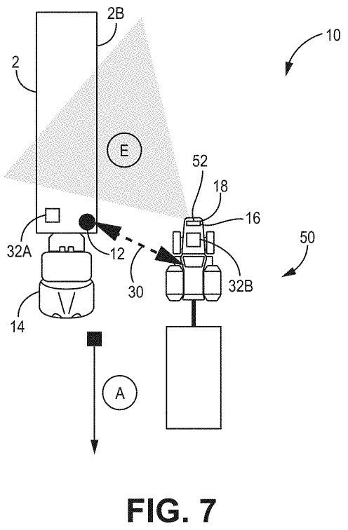

FIG. 7 depicts an implementation of the system 10 having a multi-dimensional or scanning sensor 52 having a field of view shown at E. Such sensor fusion 50 implementations may use a variety of such multi-dimensional or scanning sensor 52 including but not limited to three-dimensional flash LiDAR, single-plane scanning LiDAR and multi-plane scanning LiDAR.

In these implementations, the truck-mounted GNSS receiver 12 and wireless data link 30 provides a position and orientation information for the grain truck 14 to the grain cart 18. The multi-dimensional distance sensors 52 are mounted to the grain cart 18 such that the sensor field of view E contains some or part of the grain truck 14 and/or trailer 2 as the grain cart 18 approaches the truck 14 for unloading.

Unlike certain of the previously discussed GNSS-only implementations, fine accuracy is not needed from the GNSS receivers 12, 16 because the grain cart 18 mounted distance sensors 52 are used to more accurately determine the orientation of the grain truck 14 and measure the separation distance from the grain truck 14/trailer 2. That is, multi-dimensional sensors 52 detect the grain truck 14 and trailer 2 as a single or multi-dimensional series of points relative to the sensor 52 (on the grain cart 18 tractor or wagon). In certain implementations, the cart ECU 22 can filter out all objects that are surveyed outside the area reported by the grain truck's positional sensor 12. Line or plane detection algorithms can detect the long side 2B of the grain truck 14, that is, the side 2B of the grain truck 14 that the grain cart 18 should drive parallel to at the proper separation distance to achieve onloading (or grain transfer).

### 2D and 3D Distance Sensors

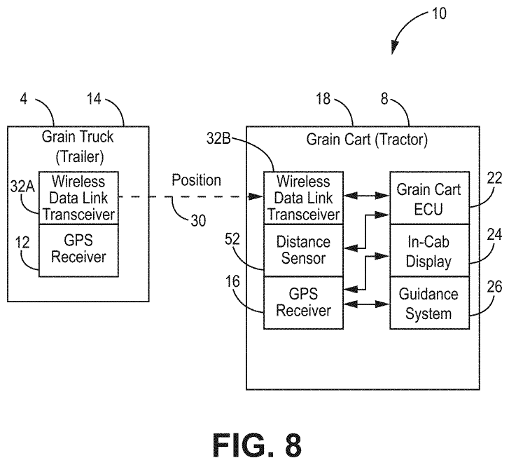

Turning now to FIG. 8, in certain implementations, a distance sensor 52 is mounted on the grain cart 18 to determine the location and orientation of the grain truck 14. Again, various implementations also feature grain cart GNSS receiver 16, as well as an ECU 22, display 24, and guidance system 26 as well as an optional data link transceiver 32B, these components being in wired or wireless communication with one another to achieve the functions described herein.

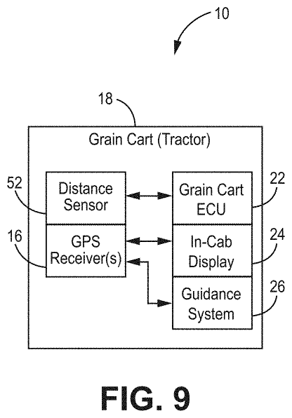

As shown in FIG. 9, in alternate implementations, the optional data link transceiver 32B or communications component 32B is not required for providing guidance to the grain cart 18.

In implementations of the system 10 utilizing 2D and/or 3D distance sensors 52, certain non-limiting examples of such sensors 52 include LiDAR, structured light sensors, stereo cameras, and time of flight sensors such as flash LiDAR.

Alternate implementations feature a single passive imaging sensor 52 configured to detect signifiers, such as a pattern of distinctive colored or black and white patches and/or lights mounted on the grain truck 14, as will be discussed further below. Using prior knowledge of the patches or lights' position on the grain truck 14, an accurate distance and orientation could be determined, as is discussed in U.S. application Ser. No. 16/947,827, which is incorporated herein by reference.

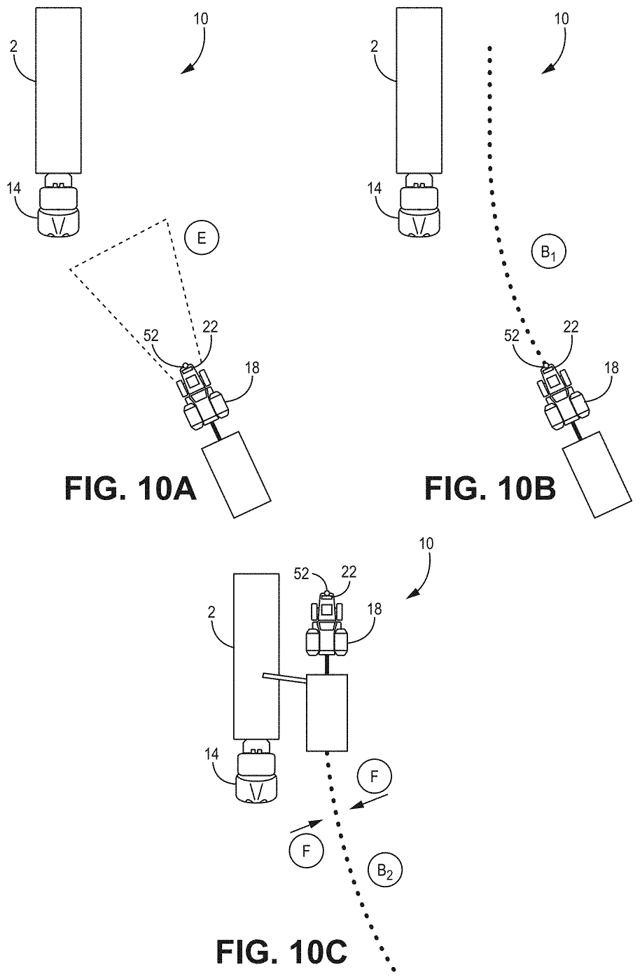

In these implementations, as shown in the various implementations of FIGS. 10A-10C, the sensor 52 is configured to detect truck 14 position and/or orientation via its field of view (shown at E). In these implementations, the sensor 52 is in electronic communication with the grain cart ECU 22 which uses the position and orientation of the truck 14 along with its own GNSS position (from the receiver 16) and orientation to determine the distance from, and relative orientation to, the grain truck 14.

The grain cart ECU 22 can, in various implementations, be configured to optionally present relative distance and orientation data to the grain cart operator to allow manual guidance along the correct path guidance line B via the display 24 and/or input to the grain cart's automatic guidance system 26 to correctly position and align the grain cart 18 to the truck 14 for unloading via a guidance line B, as would be understood. The position and orientation may continue to be updated as the cart 18 travels along and may be used to adjust the guidance lines B₁, B₂ as needed, as is shown in FIGS. 10B-10C at optional reference arrows F.

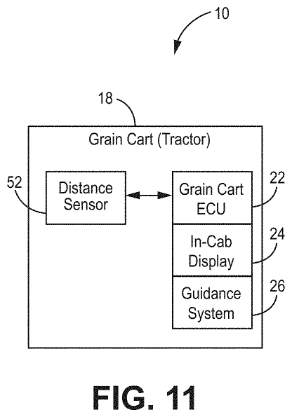

Alternately, as shown in the schematic of FIG. 11, the system 10 can rely solely on the distance measurement sensor 52 for alignment guidance during the approach. It is appreciated that this would only require relative distance and orientation data and not require global position information from a GNSS receiver 12, 16.

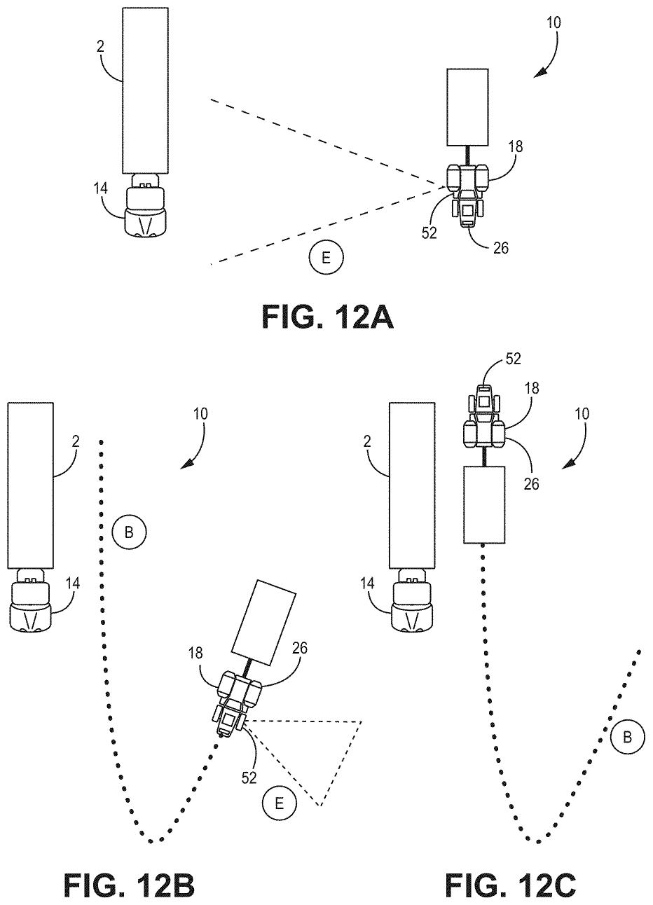

As illustrated in FIGS. 12-21, it is appreciated that there can be additional challenges that may be encountered during execution of the steps/processes/methods described above. It is understood that several example implementations are discussed, and that each may be utilized individually or in combination by system 10 and grain truck 14/grain cart 18 component configurations discussed above to plot guidance lines B for approach, as would be readily understood.

### Time Delay

It would be understood that in certain implementations, a cloud server system 31 has a time delay for the transmission of data between vehicles. For example, there may be a time delay between the GNSS receiver 12 of the grain truck 14 measuring the heading A and transmission of that data to the cloud system 31 and subsequent transmission of the data to the grain cart 18 for navigation. This delay can complicate the effective guidance of the grain cart 18 in relation to the grain truck 14, or vice versa as would be understood. In various implementations, the system 10 may be configured to only use position and orientation data from the first vehicle (such as the grain truck 14) after it has come to rest in the final position prior to receiving grain from the grain cart 18. The final position state of the grain truck 14 could be identified by the grain truck operator via a display, similar to the display 24 of the grain cart 18, smart phone, or other electronic communication device.

In alternative implementations, the system 10 may be configured to automatically detect a final state position when the grain truck 14 or other vehicle has remained in a static position for a threshold period. For example, the system 10 may report a final state position of a grain truck 14 when the grain truck 14 has remained in a static position for more than 60 seconds, although other time periods would be possible and understood by those of skill in the art. In certain implementations, the system 10 is configured for reporting final state position both automatically and via a user input as discussed above.

In a further implementation, the system 10 may be further configured to only report a final state position of a grain truck 14 when that the grain truck 14 is within a geographically defined set of bounds. In still further implementations, the system 10 is further configured to reset or remove the final state position of a vehicle, such as a grain truck 14, when the vehicle moves after a final state position is set. This resetting or removal may be automatic when the system 10 detects movement of the grain truck 14. The final state position may be reset when the required conditions are met a second time.

### Field of View

One potential challenge faced is that the cart 18 may approach the grain truck 14 in a direction that does not maintain the grain truck 14 in the field of view E of the distance sensor 52 at the moment when the operator desires to create and follow a guidance line B, as is shown generally in FIGS. 12A-C.

In the implementation of FIGS. 12A-C, the cart ECU 22 uses data from the distance sensor 52 from an earlier pass when the grain truck 14 was in the field of view E of the sensor 52. By using the measured distance and direction to the grain truck 14 and the cart's 18 current reported position from its navigational system 26, such as GNSS, at that moment it may survey the grain truck's 14 position and orientation and store the geospatial location in the ECU 22. Later, when the cart 18 requires the position and orientation information of the grain truck 14 to plot a guidance line B, it will retrieve the position and orientation information from the ECU 22.

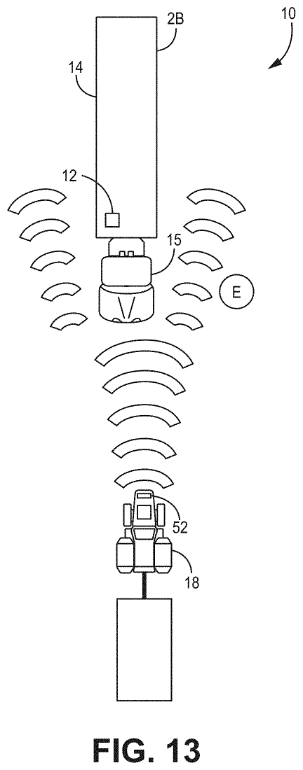

In another potential challenge, the distance sensor 52 may have the grain truck 14 in its field of view E when a guidance line B is desired, but critical areas such as the sides 2B of the grain truck trailer may be blocked from view by other parts of the grain truck 14, such as the cab 15, as shown for example in FIG. 13. This prevents direct measurement of the grain truck 14 trailer 2 orientation. Even if the grain truck 14 is additionally equipped with a GNSS 12 it may not provide sufficiently accurate heading due to slow speeds, lateral motion caused by rolling terrain, or poor or nonexistent GNSS error correction sources, such as but not limited to those discussed above.

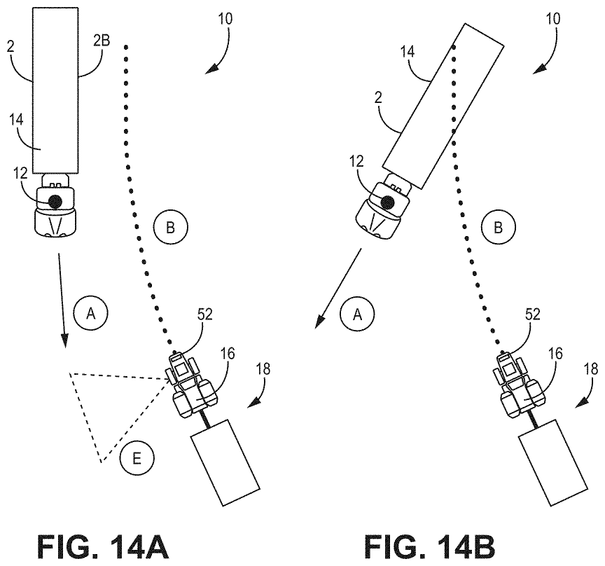

Certain approaches utilize a GNSS position sensor 16 on the tractor 18 in combination with an imaging sensor 52, which is referred to herein as a distance sensor 52, that measures the lateral separation between the grain truck 14 and tractor or grain cart 18. While it is appreciated that this can be sufficient after the cart 18 has pulled roughly parallel with the grain truck 14, it is insufficient to determine the orientation of the grain truck 14 prior to pulling parallel, as is shown in FIGS. 14A-B. For smooth, reliable guidance of the grain cart 18 alongside the grain truck 14 the grain truck's orientation must be established at least 25 feet away from the grain truck 14. The tractor 18 may not even have line of sight E to the side 2B of the grain truck 14 at this point, as is shown in FIG. 14A.

### Unique Identifiers

Another potential challenge is distinguishing the grain truck 14 from other vehicles, including other grain trucks 14, other vehicles, and other large objects in the vicinity. To aid in uniquely identifying the grain truck 14/trailer 2 of interest, according to various implementations of the system 10 a number of possible approaches may be employed.

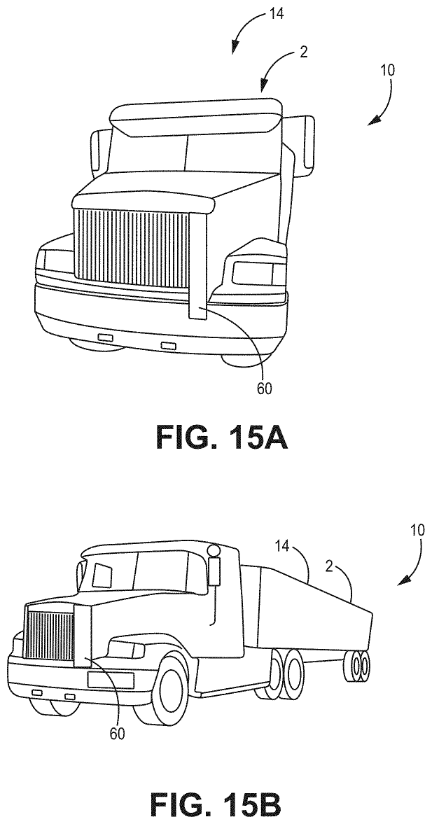

In certain implementations, one or more reflectors 60, 60A, 60B (shown for example in FIGS. 15A-20D) may be used with any of the distance sensors 52 that rely on reflected electromagnetic emissions discussed above. These reflectors 60, 60A, 60B result in higher intensity returns at the sensor 52 when compared to the surrounding surfaces they're mounted on, Further, the various reflectors 60, 60A, 60B can be applied in a pattern, color or shape that is uniquely identifiable from other pre-existing reflectors on the vehicle 14 or other common nearby objects.

It is further understood that in implementations where multiple grain trucks 14 are used in the operation, each truck 14 may have its own distinctive reflector pattern different from the other trucks 14. That is the reflectors 60, 60A, 60B are unique identifiers for the trucks 14. These reflector patterns/unique identifiers can be stored in the respective ECUs 20, 22 and used to identify the specific truck 14 or cart 18. In various implementations, the reflector patterns are stored on the ECU(s) 20, 22 prior to implementation, such as via a direct connection, while in other implementations the relevant reflector 60, 60A, 60B patterns are communicated to the ECU(s) 20, 22 via the data link 30, discussed above.

Further, for passive imaging sensors 52, the reflectors 60, 60A, 60B can be replaced with colored patches or black and white patterns, like those of a QR code. Various additional approaches to the specific differentiations of the reflectors 60, 60A, 60B would be readily appreciated by the skilled artisan.

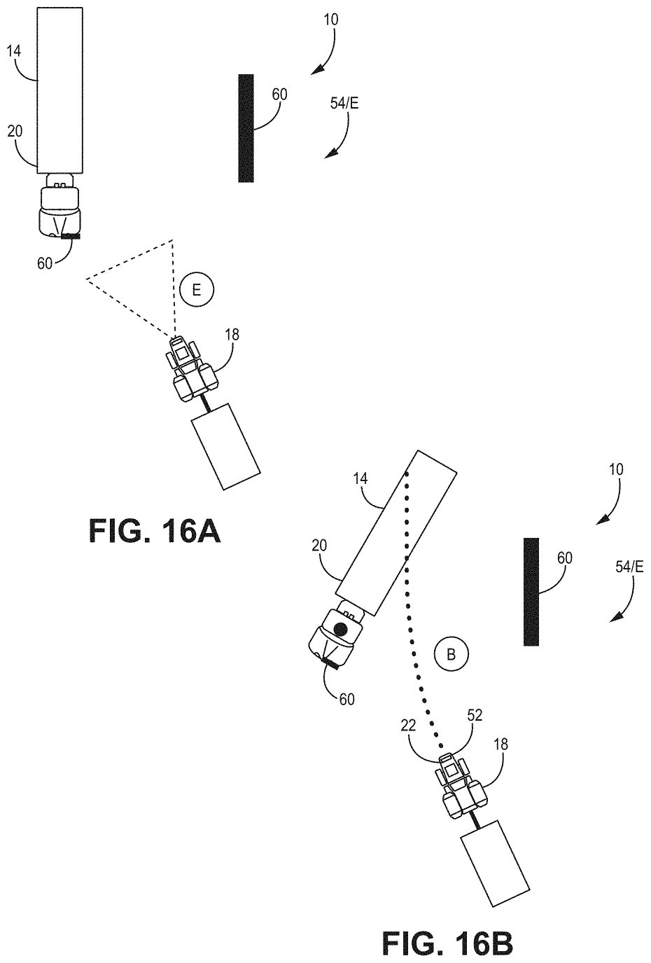

It is understood that reflectors 60, 60A, 60B or uniquely colored patches can be used for estimating lateral distance by measuring the apparent vertical height of a reflector of known height and thus calculating the distance from the point of view 54/E of the sensor 52 (also shown at E) at which this apparent height would occur. This, as shown in FIGS. 15A-16B may be insufficient for determining orientation.

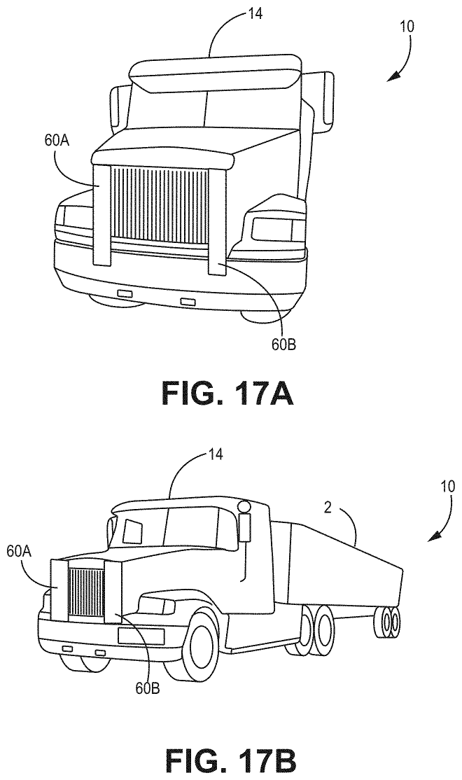

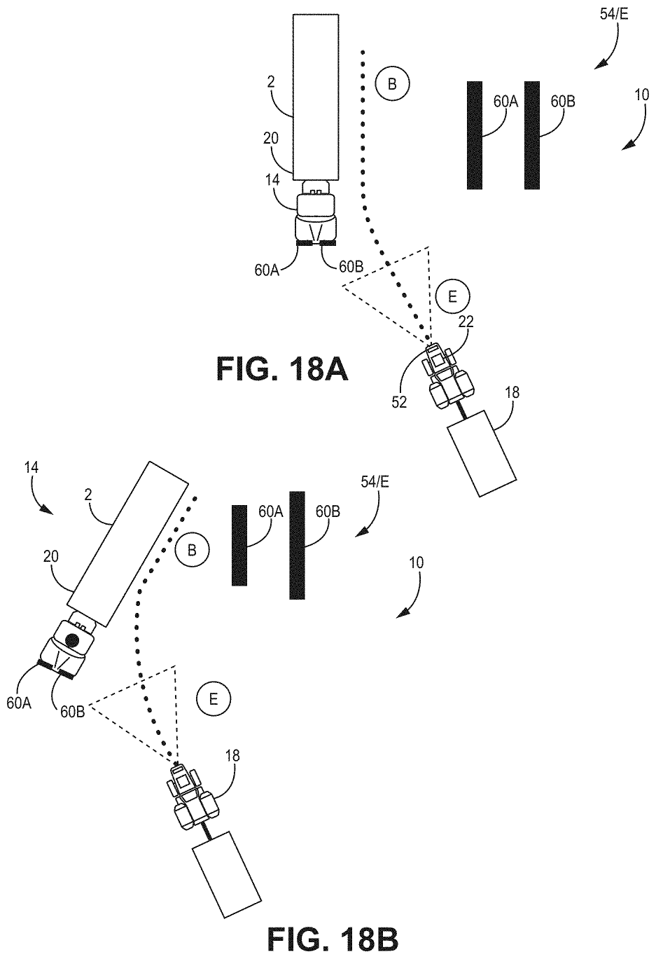

As shown in FIGS. 17A-18B, in one implementation of the system 10 orientation is determined by using two uniquely identifiable reflectors 60A, 60B set at a known lateral distance apart from each other. The distance to each reflector 60A, 60B from the cart 18 can be determined in the ECU 22 either by a height comparison and/or by direct measurement with a distance sensor, shown at 54/E.

With the distance to each reflector 60A, 60B established, a best fit line or vertical plane may be fitted to the reflectors 60A, 60B. This establishes both the position and orientation of the grain truck 14 and allows for effective path B planning, as shown in FIGS. 18A-B. It is understood that this approach is not restricted to this pattern of two reflectors 60A, 60B. Many other arrangements of multiple reflectors 60, 60A, 60B may be employed as would be readily understood by those of skill in the art.

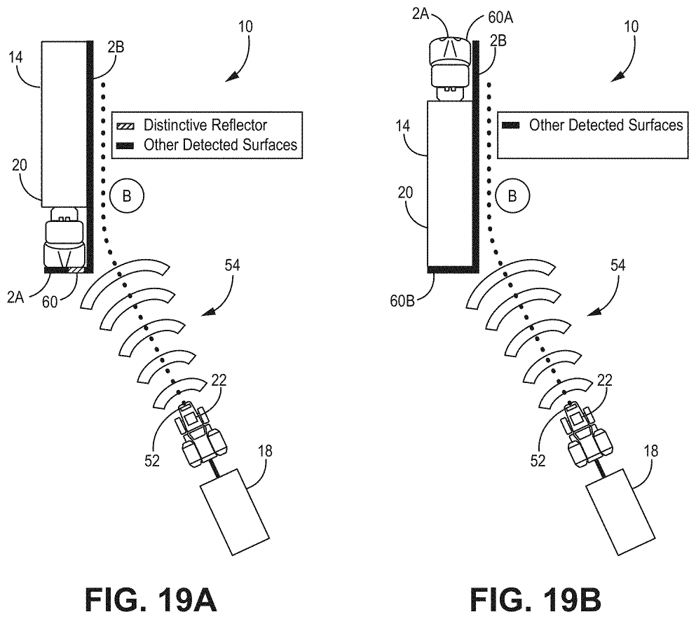

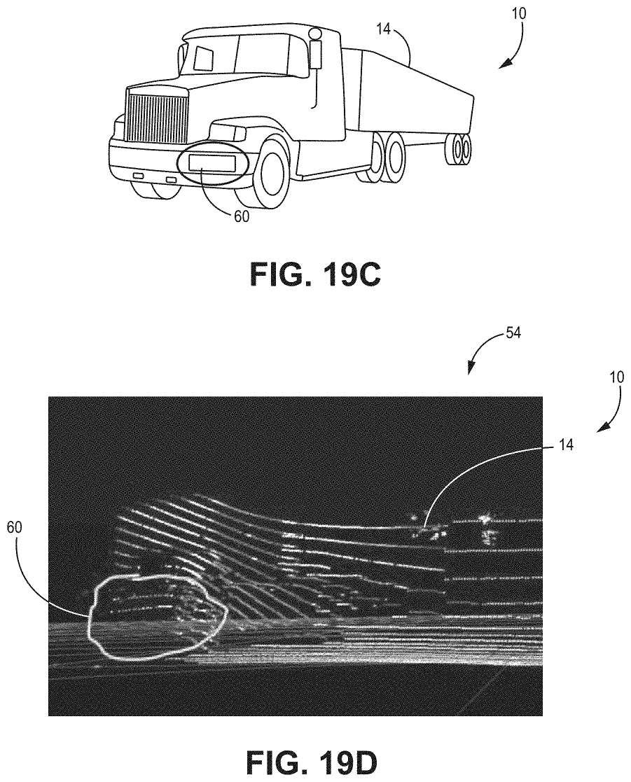

In alternate implementations of the system 10, and as shown in FIGS. 19A-D, a distinctive single reflector 60 can be used in conjunction with a high-resolution distance sensor 52 such as the Velodyne VLP-16 LiDAR sensor 52, or any other sensor configuration or heading calculation method discussed herein.

In various implementations, the LiDAR sensor 52 detects the position of the distinctive reflector 60 as well as the surrounding less distinctive surfaces. The ECU 22 can then create best fit planes on the front and/or side of the grain truck 14, depending on what is in view 54. It is understood that when the reflector 60A is mounted in a known location on the grain truck 14 and is used to accurately identify which plane is the grain truck side 2B and which is the grain truck front 2A. In further implementations, another reflector 60B distinct from the first may be mounted elsewhere on the truck 14 to assist when the first reflector 60A is out of view, such as an approach from the rear of the grain truck 14, as shown in FIG. 19B.

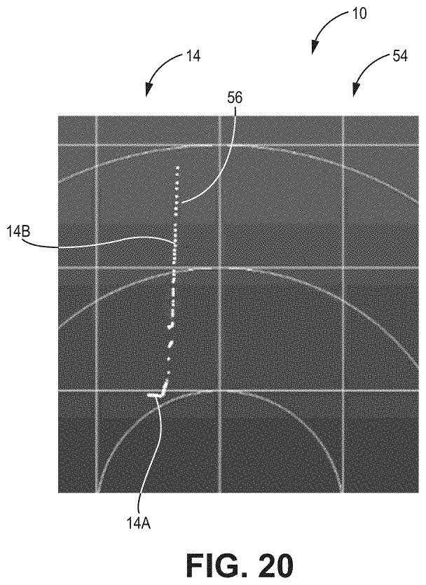

As shown in FIG. 20, the view 54 of a distance measurement system such as a 2D LiDAR can be configured for providing a single plane 56 of distance data can optionally be used with a reflector 60 to distinguish between the front 14A and side 14B of the grain truck 14, as would be understood.

A further approach, in certain implementations of the system 10, is to identify the grain truck 14 from surrounding objects by measuring various dimensions of the grain truck 14, such as the overall length, height, and/or width of the truck 14/trailer 2 or a specific feature of the grain truck 14, as would be understood. This information could be compared to the dimensions of the grain truck 14 stored in the cart ECU 22 or cloud system 31 for implementation of the guidance.

### Mapping

A further approach for locating and targeting grain trucks 14 uses a digital map stored on the cart ECU 22 that contains the geographic location of static objects large enough to be mistaken for a grain truck 14, as has been previously described. By using the measured distance and direction to a given obstacle and the current reported position of the cart 18 from its navigational system 26, such as GNSS receiver 16, it can survey the obstacle position and compare its location to known locations stored in the map. If the detected object's location matches an object stored in the map, it can be ignored as a potential grain truck 14, such as for implementation of the guidance system 26.

Certain implementations of the system 10 define a geographic region of interest where a grain truck 14 is expected to park. Any objects detected outside the region of interest are ignored by the cart ECU 22/guidance system 26. In use according to certain of these implementations, upon approach the operator is able to initiate an approach sequence in the ECU 22 such that the guidance system 26 begins searching for the grain truck 14, as would be appreciated. It is further understood that in various implementations, the ECU 22 can be utilized with machine learning or artificial intelligence so as to be trained to locate the grain truck 14.

### User Input

Further implementations of the system 10 incorporate user input by the tractor operator providing an input to the ECU 22 indicating that the grain truck 14 is within a defined range, direction and/or distance from the cart 18. Objects detected outside the defined range are ignored by the cart ECU 22 and guidance system 26. In one illustrative implementation, the tractor operator provides input when the grain truck 14 is within about 30 degrees of the front of the cart 18 and between about 40 and about 60 feet distant from the grain truck 14.

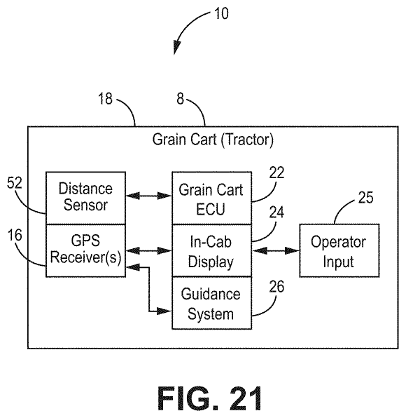

Further implementations allow the tractor ECU 22 to present multiple detected objects to the tractor operator via the display 24 and optionally have the operator select the correct object via an operator input 25 on the display 24, as shown in FIG. 21.

It is appreciated that the approaches listed above may be also used in combination. If the solution provides unique identification of individual grain trucks 14, the identification information can optionally be stored in the ECU 22 or cloud system 31 along with tracking information about the grain loaded onto the truck 14 such as grain variety, harvest location and the like.

### Grain Cart Feature Adjustment

### Auger and Spout Adjustment

While unloading, the disclosed systems, methods and devices can control various grain cart features, such as the forward travel speed, spout position, unload auger pitch, unload feed gate, and PTO speed to fully and evenly fill the receiving grain truck 14 box/trailer 2.

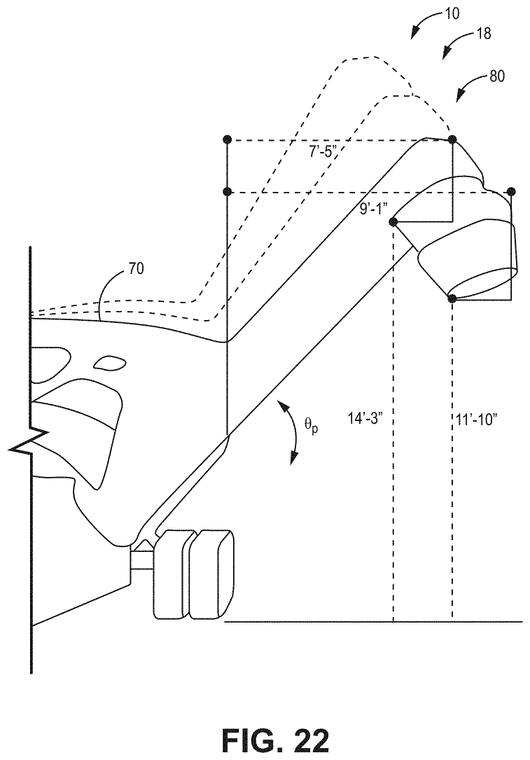

In further aspects of the system 10, and as shown in FIG. 22, it is understood certain grain cart 18 wagons can change the angle at which the unload auger 70 projects out from the wagon 18. The projection angle θₚ is typically controlled manually by the grain cart operator via hydraulics 84 to allow the unload position and height to be adjusted without having to move the entire cart 18. It is further understood that various other grain carts include adjustable features.

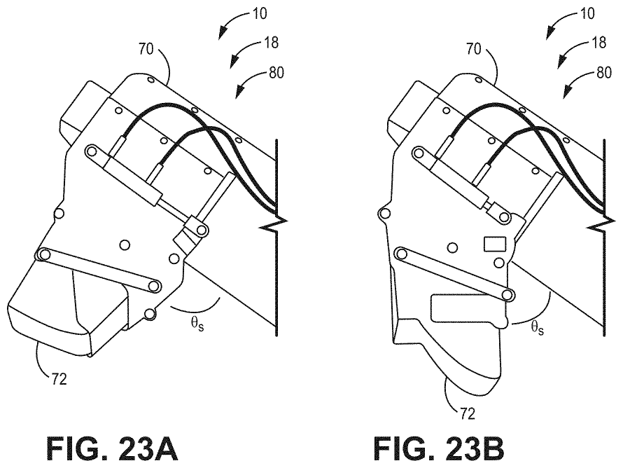

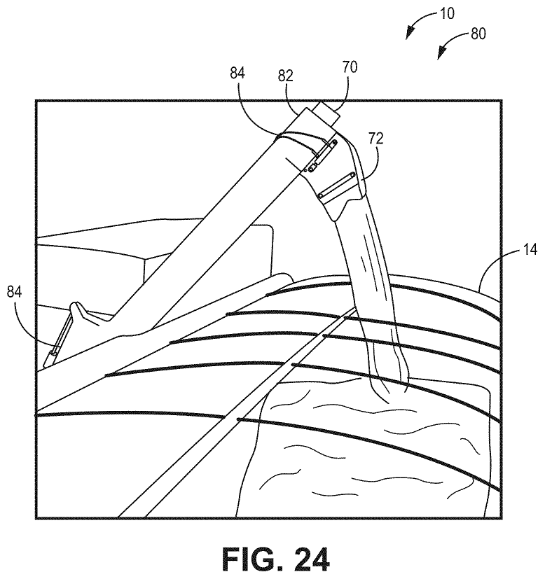

As shown in FIGS. 23A-24, another adjustable aspect of some grain carts 18 is the spout 72, or deflector, at the end of the unload auger 70 where the grain exits. The spout 72 angle θₛ is also presently controlled manually by the grain cart operator via hydraulics 84 to allow a change to the trajectory of the grain exiting the unload auger 70. This facilitates positioning the stream of transferring grain for optimal loading of the grain truck 14, either to adjust for misalignment or to even piling across the width of the truck 14.

In various implementations of the system 10, an automatic auger control system 80 can be used to automatically adjust the unload auger projection angle θₚ, unload spout angle θₛ and/or other adjustable grain cart feature. In these implementations, a GNSS receiver 82 is positioned on the unload auger 70, preferably near the top, as shown in FIG. 24. When combined with the positioning systems discussed above, the exact position of the unload auger 70 is known and stored by the grain cart 18 ECU 22.

Accordingly, the auger control system 80 is able to automatically adjust unload auger 70 projection angle θₚ and/or unload spout angle θₛ to optimally fill the grain truck 14 as determined by, for example, an auger algorithm. The auger control system 80 can then move the unload auger components in a pre-determined pattern during unloading to evenly distribute the unloaded grain in the truck 14, such as via the auger hydraulics 84.

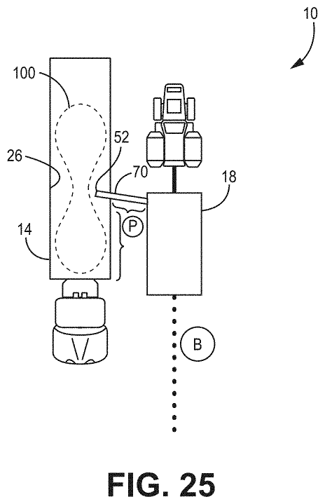

In further implementations of the system, the GNSS receiver 82 is replaced by a distance sensor 52 positioned on the unload auger 70 or the grain truck 14 with a field of view that includes the interior 2C of the grain truck 14, as shown in FIG. 25. The distance sensor 52 provides data on the grain distribution (shown generally at 100) in the grain truck 14 in addition to the auger 70 position relative to the grain truck 14 (shown generally at P). The auger control system 80 is thus able to change the unload auger projection angle θₚ and/or unload spout angle θₛ to optimally fill the grain truck 14. Again, according to these implementations, auger control system 80 is configured to move the unload auger 70 components in a pre-determined pattern during unloading to evenly distribute the unloaded grain in the truck or in response to the grain level data provided by the sensor 52.

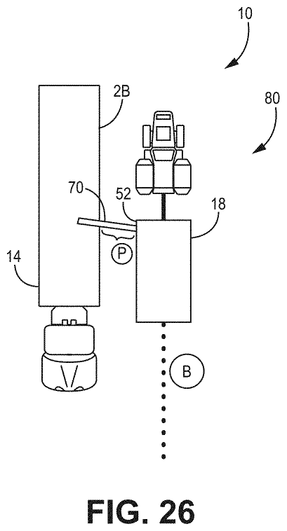

In another implementation of the auger control system 80 shown in FIG. 26, a distance sensor 52 is installed on the grain cart 18 (oriented at the side 2B of the grain truck 14 and configured to measure the horizontal distance (again shown at P) between the grain cart 18 and truck 14. The auger control system 80 automatically adjusts the auger projection angle θₚ and/or unload spout angle θₛ via hydraulics (shown, for example, in FIG. 24 at 84) to compensate for any lateral misalignment between the grain cart 18 and grain truck 14 from the guidance line 18/actual position of the truck 14. In these implementations, the system 80 can be set as a default to adjust the auger projection angle θₚ and/or unload spout angle θₛ to dispense grain in the center or middle of the grain truck 14. Heaping the grain pile in the center evenly fills the truck to its maximum volumetric capacity. Other default positionings are of course possible, however, depending on the given implementation.

Although the disclosure has been described with reference to preferred embodiments, persons skilled in the art will recognize that changes may be made in form and detail without departing from the spirit and scope of the disclosed apparatus, systems, and methods.

What is claimed is:

1. A grain cart guidance system, comprising:
(a) at least one GNSS receiver and
(b) at least one cart ECU in communication with the at least one GNSS receiver,
wherein the grain cart guidance system is configured to plot a grain cart guidance line for alignment of the grain cart along one or more grain trucks.

2. The guidance system of claim 1, further comprising an auger control system.

3. The grain cart guidance system of claim 1, wherein the at least one GNSS receiver is configured to determine one or more of a position of the one or more grain trucks, a heading of the one or more grain trucks, and a speed of the one or more grain trucks.

4. The grain cart guidance system of claim 1, further comprising a display for displaying the grain cart guidance line for manual navigation by an operator.

5. The grain cart guidance system of claim 1, wherein the guidance system is in communication with an automatic steering system for automatic steering of the grain cart along the grain cart guidance line.

6. The grain cart guidance system of claim 1, further comprising at least two GNSS receivers disposed on the each of the one or more grain trucks and in communication with the at least one cart ECU.

7. The grain cart guidance system of claim 1, further comprising one or more multi-dimensional sensors disposed on the grain cart configured to measure an orientation of the one or more grain trucks and relative positions of the one or more grain trucks and grain cart.

8. An agricultural guidance system, comprising:
(a) a position sensor configured to determine a location and an orientation of a grain truck relative to a grain cart and
(b) a processor configured to receive the location and the orientation of the grain truck relative to the grain cart,
wherein the system is configured to generate one or more guidance paths for alignment of the grain cart and the grain truck.

9. The agricultural guidance system of claim 8, wherein the position sensor is one or more of a GNSS receiver, a 2D distance sensor, and a 3D distance sensor.

10. The agricultural guidance system of claim 8, further comprising one or more reflectors comprising distinct patterns for identification of the grain cart and the grain truck.

11. The agricultural guidance system of claim 8, further comprising a display configured to display the one or more guidance paths to an operator for navigation.

12. The agricultural guidance system of claim 8, wherein the grain cart comprises an adjustable spout, and wherein the system is configured to position the adjustable spout to distribute grain in the grain truck.

13. The agricultural guidance system of claim 12, wherein the system is configured to automatically adjust a projection angle and/or a spout angle of the adjustable spout.

14. The agricultural guidance system of claim 12, wherein the system is configured to position the adjustable spout to correct any misalignment of the grain cart and grain truck.

15. A guidance system for a grain cart and a grain truck, comprising:
(a) a first position sensor disposed on the grain cart, the first position sensor configured to determine at least one of location, heading, and speed of the grain cart;
(b) a first electronic control unit (ECU) disposed on the grain cart and in communication with the first position sensor;
(c) a second position sensor disposed on the grain truck, the second position sensor configured to determine at least one of location, heading, and speed of the grain truck;
(d) a second ECU disposed on the grain truck and in communication with the second position sensor; and
(e) a data link between first ECU and the second ECU,
wherein the system is configured to plot one or more grain cart guidance lines for alignment of the grain cart along the grain truck.

16. The system of claim 15, further comprising a third position sensor disposed on the grain truck and in communication with the second position sensor.

17. The system of claim 15, further comprising a cloud-based server, wherein the first ECU and the second ECU are in electronic communication with the cloud-based server.

18. The system of claim 15, wherein the data link is an integrated cellular modem, a WiFi connection, a cellular hotspot.

19. The system of claim 15, wherein an automatic steering system on the grain cart steers the grain cart along the one or more grain cart guidance lines.

20. The system of claim 15, further comprising one or more distance sensors disposed on the grain truck and/or the grain cart configured to determine an orientation of the grain truck.
